(19) United States
(12) Patent Application Publication
(10) Pub. No.: US 2020/0090100 A1
(43) Pub. Date: Mar. 19, 2020

(54) METHOD AND SYSTEM FOR ATTRIBUTING AND PREDICTING SUCCESS OF RESEARCH AND DEVELOPMENT PROCESSES

(71) Applicants: LAWRENCE D. FU, San Diego, CA (US); KONSTANTINOS (CONSTANTIN) ALIFERIS, Minneapolis, MN (US)

(72) Inventors: LAWRENCE D. FU, San Diego, CA (US); KONSTANTINOS (CONSTANTIN) ALIFERIS, Minneapolis, MN (US)

(21) Appl. No.: 16/423,890

(22) Filed: May 28, 2019

Related U.S. Application Data
(63) Continuation of application No. 14/623,428, filed on Feb. 16, 2015, now abandoned.
(60) Provisional application No. 61/940,727, filed on Feb. 17, 2014.

(51) Int. Cl. G06Q 10/06

(52) U.S. Cl. CPC G06Q 10/06375; G06Q 10/0635; G06Q 10/067

(57) ABSTRACT

A system and method for identifying critical positive and negative factors for the success of a research and development activity.

This application is a continuation of and claims the benefit of U.S. application Ser. No. 14/623,428 filed Feb. 16, 2015 which claims priority from provisional application 61940727, filed Feb. 17, 2014.

### BACKGROUND OF THE INVENTION

### Field of the Invention and Brief Description of Related Art

Research and Development (R&D) are investigative activities that a business or other organizations conduct with the intention of making discoveries that can either lead to the development of new products or procedures, or to improvement of existing products or procedures. R&D may proceed in linear or non-linear manner and typically involve several steps over long periods of time.

Every field of industry engages in extensive efforts of Research and Development for New Product Development. In many industries, such R&D may last for years or decades and costs may reach or exceed the multi-billion dollar range (as for example in Pharmaceutical development, Defense and other fields of application). A major problem in managing such R&D is that of optimally allocating resources to competing R&D activities since it is not generally known which research activities are most likely to “convert” to scientific-technological results that facilitate new products. Another problem is to accelerate the successful R&D efforts and eliminate the unsuccessful ones as early as possible.

For example in the Life Sciences, the process of “Translational Research” describes the research activities that eventually lead to practical applied innovations such as new diagnostic technologies/products, new drugs, improvements in the guidelines that determine the standard of care etc. Both private industry (e.g., Pharmaceutical companies) and the public sector (e.g., Federal Funding agencies such as the NIH) are faced with the pressing problem of allocating limited resources to a small number of efforts out of many candidate R&D initiatives. In many cases, one has to decide which R&D programs that have yielded partial results should be prioritized over other incomplete or yet-to-begin ones. In addition, since the time-to-market directly affects profitability (e.g., at the tune of >1 billion USD/year for “blockbuster” drugs), it is highly desirable to accelerate the R&D that is likely to be successful and eliminate the R&D that is likely to be unsuccessful as early as possible .

The same considerations are true for all industries where R&D plays a significant role in New Product Development (NPD). Examples include: electronics, telecommunications, computer and information technology, defense, aeronautics, aviation and aerospace, Internet commerce, financing and investing, energy, automotive and transportation, marketing and advertising to name a few.

The present invention provides a method, process and apparatus for:
a. Designating high impact and low impact milestones in the R&D process for NPD.
b. Predicting the future likelihood that a particular stage of R&D may lead to conversion to a successful outcome in the R&D chain.
c. Identifying critical positive and negative factors that affect eventual R&D success or failure.

Users of the invention may use it for:
i. Understanding the enablers of fast/successful R&D and the obstacles to fast/successful R&D so that R&D practices, processes and management can be improved upon.
ii. Improving resource allocation to competing R&D activities such that research activities that are most likely to “convert” to scientific-technological results that facilitate new products are preferentially funded and ones that are likely to fail are preferentially de-funded.
iii. Accelerating the time horizon of R&D efforts that are likely to be successful and shortening the time invested on R&D that is likely to be unsuccessful.
   The invention employs methods and techniques from mathematical modeling (Markov Processes), Statistics and Machine Learning (Predictive modeling), Scientometrics, and Network Science (Dependency and Influence Graphs).

### BRIEF DESCRIPTION OF THE FIGURES AND TABLES

FIG. 1 depicts, in the Translational Research Field of Application, the citation path tracing translational success in the scientific literature from the initial basic science discovery until a clinical endpoint.

FIG. 2 depicts a possible set of Markov Process states and transitions in the Translational Research Field of Application. This set is not intended as an exhaustive or definitive list.

Table 1 lists example input features for Model Training in the Translational Research Field of Application. These features can either be content-based or meta-data (e.g., bibliometric) features. Content features are based on document content such as the title or abstract. Bibliometric features are information based on the authors, publication, or other metadata.

Table 2 lists the top 10 important features for two use cases with different training corpora in Translational Research Field of Application.

### DETAILED DESCRIPTION OF THE INVENTION

The invention method comprises 3 stages, which are implemented in the system described and claimed.

I. Knowledge Base Creation & Configuration to the Specific Field of Application

Creating this Knowledge Base involves the following elements:
1. Units of prediction that are of interest to users and appropriate to the field of application. For example, in the domain of life sciences R&D, an appropriate unit of prediction may be the stage of research toward a new drug as evidenced by development and publication of basic science or clinical findings. The unit of prediction will typically be a complex relationship of objects; for example in drug development it can be the usefulness, applicability or potential of a particular molecule for a safe and efficacious new drug.
2. An instrumental set of “endpoint exemplars” that constitute or represent archetypes or milestones of success of the R&D process. In the new drug development example, these may be clinical trials that prove the improved efficacy or safety of a new drug over the best drugs currently in market.
3. A Dependency/Influence Network representation of instrumental influences among stages of R&D appropriate to the field of application. In the drug development example, such a network can be a citation graph among articles, websites and patents that indicate how various molecules, pathways, assaying technologies etc. gradually support the development of a new drug. The nature of influences in the Dependency Network may vary dramatically among distinct fields of application and needs be tailored accordingly. Appropriate networks include citation influences in a citation network of articles or web pages, causal relationships in a causal graph, information transfer relationships in an information network, resource input relationships, or any other appropriate network representation of how stages of R&D influence and depend on one another.

II. Ex Post Facto R&D Success Model and Corresponding Decision Support System

Creating this model and decision support system involves the following elements:
a. Initialize an empty working dependency graph model and add to it the “endpoint exemplar” set from the knowledge base.
b. Add to the working graph, going back in order of influence from the endpoint exemplars to the most immediate influencing objects, recursively.
c. Stop when no more dependency relationships exist in the knowledge base or when the knowledge base is exhausted.

The model can now be used to assess retroactively (i.e., “historically”) the impact of a stage of R&D to successful endpoints by using standard graph algorithms for determining all paths from a stage or stages of interest to one or more success exemplars of interest. Existence of one or more paths is direct evidence for the impact of a stage of R&D to the success of the overall effort, lack thereof is evidence for lack of impact. Other ways to describe and infer macro properties of the R&D process modelled by the graph model and identify critical components include a variety of standard Network Science analytics tools (e.g., clustering coefficient, hubs, percent shortest path, characteristic path length, Betweeness Centrality, clusters etc.)

III. Prospective Predictive R&D Success Model and Corresponding Decision Support System

Creating this model and decision support system involves the following elements:
a. Markov Process explicit R&D success model. This model provides a granular description of sub-stages of R&D success, for example specific progress transitions from user-defined and field application specific sub-stages. In the drug development example, such stages may be stage transitions where a basic science discovery immediately leads to a new drug, or conversely stays “dormant” (or unnoticed by the scientific community) and fails to have translational impact, waiting to be picked up for later development etc.
b. Predictive R&D success model(s). These models explicitly predict state transitions among the Markov Process states previously described. For example in the drug discovery domain, they may model the likelihood that a patent, announcement, or scientific article describing a new molecule may lead to an FDA-approved new drug. The state transition prediction models may involve adjacent or non-adjacent Markov Process states and may also aggregate multiple transition paths.
   While construction of Markov Process models follows procedures in Decision Analysis, Operations Research and Applied Mathematics that are related to those of the prior art, the construction of predictive models uses established principles of predictive modeling highly customized for the purposes of the invention.

The steps followed include:
Data Design
Feature Selection and tuning
Classifier selection and tuning
Model Selection
Error Estimation
Model explanation, fine tuning (e.g., calibration), and analysis
Model performance optimization
Production model construction and deployment

The provided technical report (attached hereto as Appendix 1, and incorporated herein by reference) provides details of the method as applied to the specific field of application of R&D for the Life Sciences (also commonly labeled as “Translational Research”). It demonstrates empirically that the invention leads to accurate predictions and in depth understanding of R&D process in a real-life complex domain (that of translational biomedical research leading to new drug development).

### Differences From Prior Art In Predictive Modeling

Differences from General-Purpose Text Categorization and Classification Methods
1. Unit of prediction. The invention categorizes not the internal content or other de-contextualized properties of a single stage in the R&D process but a specific type of complex relationship of a single stage with the set of R&D successes. That is what is classified and predicted is the future relationship of a stage of the R&D with yet-to-be realized (possible) endpoints of R&D process, directly or through other R&D stages.
2. Construction of positives and negatives for training of predictive modeling.
   a. Invention incorporates the critical identification of an instrumental set of “endpoint exemplars” that implicitly provides archetypes of success of the R&D process.
   b. Invention requires a dependency network representation of influences among stages of R&D. These influences may be for example citation influences in a citation network of articles, causal relationships in a causal graph, information transfer relationships in an information network, resource input relationships or other appropriate network representations of how stages of R&D influence and depend on one another.

These endpoint exemplars are NOT training exemplars for predictive modeling but need to be coupled with the dependence network that tracks paths from any stage of interest to the endpoint exemplars.
3. Specific techniques and processes for enabling construction of training corpora in addition to dependency networks and exemplar endpoints. These include specialized processing methods for trimming the dependency network from false positive links; specialized filtering procedures for restricting the space of all stages to stages that are most relevant to the R&D success prediction task; and a multi-level modeling approach whereby the overall transition from initiation of R&D to success or failure endpoints is modeled via a Markov Process and transition probabilities are provided by predictive modeling.
4. Dual Mode of Use.
   a. Prospective (predictive) and
   b. Retrospective (attributive) ex post facto explanatory modes of operation of the invention.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority, if any) and that no narrowing of the scope of the appended claims be allowed due to subsequent changes in the law, as such a narrowing would constitute an ex post facto adjudication, and a taking without due process or just compensation.

### Appendix 1

Predicting and Understanding Success of Translational Research and Development in The Life Sciences

### Abstract

Translational research is a notoriously hard endeavor that requires significant amounts of time and effort, and it is currently poorly understood from a process perspective. The goal of this work is to improve the understanding of the process eventually leading to improved efficiency of translation. Our overarching program seeks to: (a) develop a quantitative predictive framework for large-scale modeling translational research, (b) to use the framework to identify examples of translational success, and (c) to analyze these cases to determine factors that lead to translational success. Our approach utilizes a Markov process methodology combined with custom citation analysis, and special-purpose predictive modeling (comprising task-customized machine-learning based text categorization techniques). We demonstrate the feasibility of the approach by constructing accurate models to predict translational success based on analysis of the biomedical literature. Our experimental results show that this methodology can predict translational success with high accuracy. These initial results provide a foundation for future work that will quantitatively and accurately model the entire translational research process. Because the approach is not domain specific, it can be used for R&D processes across domains.

### Introduction

Translating basic science discoveries into clinical care is a lengthy, expensive, and currently poorly understood process. For example, it requires 13 years to produce a new drug after target discovery, the failure rate exceeds 95%, and the cost exceeds $1 billion[1]. Incorporating new knowledge into clinical care requires additional time after developing a treatment, and the entire translational process requires about 17 years [2], [3]. From the public funding point of view significant research and resources have been dedicated to improving the efficiency of translational research. Examples are the Clinical and Translational Science Awards (CTSA) and the National Center for Advancing Translational Science (NCATS). From the private industry R&D investment viewpoint, the ability to prioritize correctly among competing investment R&D targets is essential. In medical research the translational process is conceptualized as spanning 4 stages: T1, T2, T3, T4 spanning from discoveries in the lab all the way to delivering at the bedside and the patient community. Translational success requires long times since translational science is a complicated research enterprise spanning many research domains. It is currently very difficult to anticipate which basic science discoveries will impact clinical care. One reason why such a prediction is very hard is that there are relatively few examples of translational success compared to the total volume of the commercial R&D activity and the scientific literature.

The unpredictability of translational research makes it difficult to evaluate the effectiveness of efforts to accelerate translation. If public funding or industry allocate resources to one area, there is no guarantee that the translational results will materialize or even that the process will speed up. Current methods for resource allocation are based on fundamentally heuristic or otherwise unproven assumptions. A classic example is the debate of what is the best relative allocation of funds between basic and clinical science. If we allocate more funding and resources in one area (e.g., basic science), proponents of that area advocate that translation should be accelerated. Unobserved bottlenecks or unanticipated consequences may hinder the entire process and nullify the above intuitive rationale however. For example, the benefits of an increased rate of basic science discoveries could be offset by the decreased rate of clinical research due to relative smaller allocation of funds for clinical research, or due to shifts in the talent pool distribution between the two areas (among many other hard-to-predict factors).

In short one cannot currently answer major policy, investment and planning questions without a much more detailed, quantitative, and reproducibly predictive understanding the entire translational process.

An accurate model for future translational success would determine the factors that led to translational success so that translational research could become a repeatable, predictable process. The model would also identify high-impact research based on their likelihood of impacting clinical care. Such models could be used to allocate resources in a targeted, principled manner.

A number of conceptual frameworks exist for modeling translational research [4]-[7]. The specifics of each framework vary, but they share some common characteristics that Trochim combines into a “process marker model” [7]. This conceptual framework designates progress milestones throughout translational research. For example, one marker indicates when individual clinical studies are synthesized into general knowledge through meta-analyses, systematic reviews, and guidelines. The elapsed time is measured by comparing publication dates of the initial article and guideline. Existing frameworks such as this one are useful for a general understanding of translational research, but they are limited in their usability since they are not designed to be operational or to be used quantitatively for large-scale analysis.

It is worth mentioning two additional frameworks for studying the efficiency of translational research. The “Payback Model” literature quantifies research outputs to measure efficient use of funding [8]-[10]. Comroe and Dripps [11] evaluated the contribution of basic science research and clinical research to translational research, and this motivated a number of similar studies [12]-[16]. These two approaches are limited since they rely on manual literature reviews and case studies. The findings are not scalable since analyzing many topics and time periods is not feasible with manual review.

So to summarize prior efforts in this area we note that the existing work on modeling translational research has identified several factors but has several practical weaknesses (a) relies on manual review of the literature, which requires significant time and effort. (b) The findings are not necessarily generalizable since it is not feasible in practice to study more than a few topics. (c) The prior work has not produced reproducible predictive models that provide concrete estimates of future success that can be used in formal ROI and risk modeling analyses. A comprehensive, quantitative and scalable framework for modeling translational research is needed to thoroughly understand and rationally plan translational research. The ideal model should be an automated, computational method with no or minimal manual literature review so that it can span many topics and time periods. The model should enable large-scale analysis and provide accurate predictive information.

The current work proposes a methodology for modeling translational research that fulfills these requirements. The model is based on an automatically generated citation network. Translational success is indicated by a citation path between basic science research and the clinical literature. Citation information is automatically extracted from publications. Multiple states of translational progress are defined using a Markov process formulation where the probability of transitioning to a given state only depends on its previous state. Using the citation network and Markov process framework, we train machine learning models to predict which articles are likely to lead to translational success. Although we define multiple states of translational progress, this work focused on direct transition of the initial basic science discovery to translational success. This transition is equivalent to predicting which research results represented by scientific papers will lead to translational success. The long-term plan is to model all transitions as well as the entire translational research process. The preliminary results demonstrate that it is possible to train machine learning models capable of predicting translational success and confirm the feasibility of modeling translational research using this framework.

### Methods

We first describe an ex post facto framework for capturing translational success using strictly citation information. We then describe a more nuanced and semantically more informative Markov Process model that can model explicitly various intermediate steps of the translational process. We finally operationalize modeling by constructing and evaluating a truly prospective predictive model for long term translational success.

### A. Ex Post Facto Implicit Translational Success Model

In the medical scientific domain successful translational paths from basic discoveries to clinical deployment can be traced over time using citation paths between the basic science and clinical literatures. Most papers are not cited, and even fewer papers eventually impact clinical care. Yet the existing citations are numerous and form a graph reflecting vastly complicated relationships over time. Some of the relations are explicit (e.g., what paper cites which papers) and some are implicit (i.e., sets of papers describe loosely coordinated and interacting programs of research conducted by groups of researchers in several sites over time).

Because citations occur for a large number of reasons, most of the citation paths and relationships are not relevant to translational success, however.

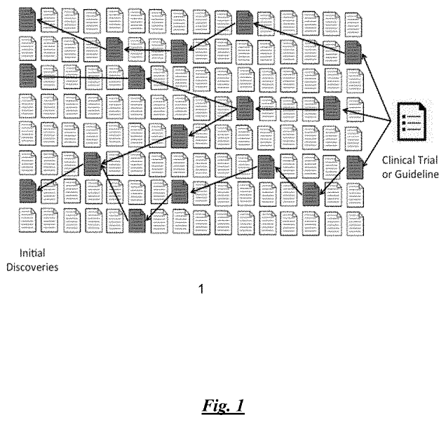

FIG. 1 visualizes a simple ex post facto citation framework for identifying articles with high translational impact. This framework can be constructed in 3 steps:
d. Identify and add to the graph an “endgame set” of articles that capture the essence of translational success according to accepted domain criteria. In medicine such articles may be for example “standard of care”, best practices, clinical guidelines, and clinical trial articles related to a particular disease, procedure or population.
e. Add, going back in time, from the cited articles in the “endgame set” to the citation graph the cited articles and expand the graph by recursive application of steps (b) for each articles added to the graph.
f. Stop when no more citations exist or the database of articles is exhausted.

This is more of an attribution framework that seeks to explain which discoveries had impact toward a clinical modality of interest.

Limitations of this framework include:
i. Not all citations describe positive impact of the cited work to the citing work. For example, some citations may dispute, or refute prior work. Or some citations may not be essential to the citing work. As a result many of the articles in the graph will be “noise” that dilutes the significance of truly important contributions and inflates the importance of inconsequential work.
ii. If one wishes to constrain the analysis to a particular field only (e.g., treatment of melanoma), for example by filtering out articles that are not melanoma specific, this threatens to exclude basic science contributions that are very foundational in nature and are not constrained to any particular disease. Assaying methods, statistical and bioinformatics as well as very foundational biological research are examples of such false negatives.
iii. The framework is constructed, as stated, ex post facto thus making prospective application impossible.
iv. Certain discoveries may still have great potential for success, but did not have enough time to affect such success or have been temporarily ignored by the research community. This is a variant of limitation (iii).
v. The framework is not very granular and fails to capture nuances of the discovery process. It jumps from report to report without explicitly modeling the precise nature of progress made along the citation history.

The next two modeling refinements (sections B and C) remove the limitations of the ex post facto citation model.

### B. Markov Process Explicit Translational Success Model

So far we utilized the fact that translational research is the transmission of knowledge from basic science research to clinical care, and this process is observable through citations. We operationally defined translational success as evidence that basic science research impacted clinical care, and this evidence is a citation path from the clinical literature (e.g., clinical guideline or clinical trial) to a basic science article. The citation path may be indirect with multiple articles connected by citations. This is the main value of the ex post facto citation model.

Other document characteristics and metadata may also provide useful information in addition to citations. Other intermediate states of translational progress also exist. We use these observations to improve upon the basic citation model using a Markov process, which consists of states and transition probabilities. The probability of transitioning to a given state only depends on the previous state. In other words, we assume that the likelihood of research leading to translational success depends on its current state of maturity and not prior steps leading to the current state of progress. The Markov process framework allows us to make useful inferences using a variety of mathematical tools such as calculating the probability of transitioning to a given state (e.g., probability that an article will lead to translational success). Later in this report we use machine learning models to provide the necessary transition probabilities.

In using the literature for analysis of translational success, articles are mapped to Markov process states based on publication metadata or citation information (e.g., types of papers citing it or cited by it, content, etc.). In many cases it is reasonable to operationally model translational success as occurring if there is a citation path (i.e., papers connected by citations) between an article and a document demonstrating clinical impact such as a clinical guideline or clinical trial. On the other hand, if a mathematical discovery is never cited by the clinical literature, then this is an example of failure of the model to capture such success due to disconnect of the two literatures. More expansive operational criteria can be used to address such limitations.

By definition, a Markov process satisfies the Markov property, which is defined as follows:

PrX=xX=x, X=x, . . . , X=x)=Pr(X X=x)

The probability of a state transition, Pr(Xₙ₊₁=x), only depends on its previous state (i.e., X=x). We use the following Markov Process states as a useful starting point for modeling translational research. This list is not intended as an exhaustive or definitive list in this application domain and we anticipate that it can be improved over time.
1. Initial Discovery phase: Discovery of new knowledge (e.g., new gene or symptom cluster (“syndrome”))
2. Translational Success phase: Clinical impact (e.g., by leading to an approved drug that exceeds in efficacy and/or safety previous drugs)
3. Translational Failure phase: Termination of research without clinical benefits.
4. Stalled Research phase: Research temporary stalls, and it is unclear if it will eventually lead to translational success.
5. Waiting State: Time passes as additional discoveries are made. Progress is being made although translational success not yet been achieved.
6. Unproductive Repetition: Repeating previously conducted work that will eventually lead to translational failure

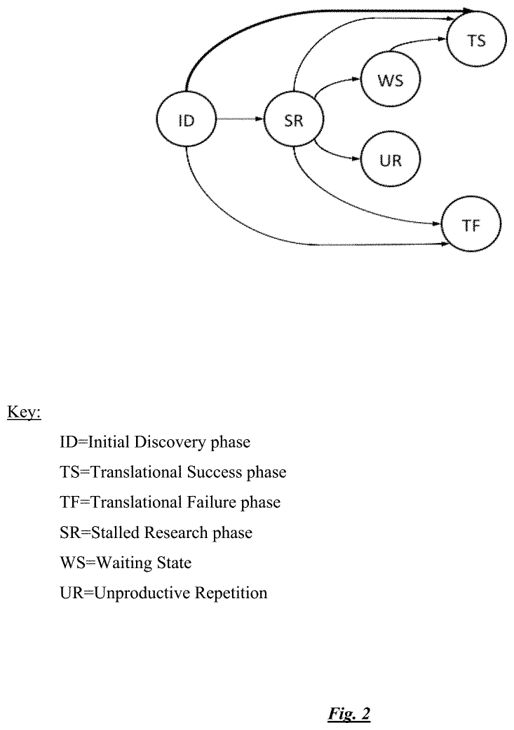

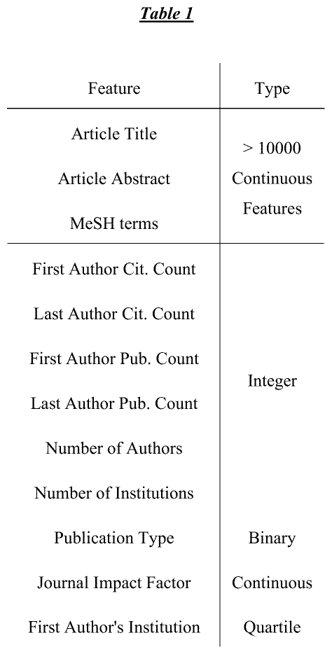

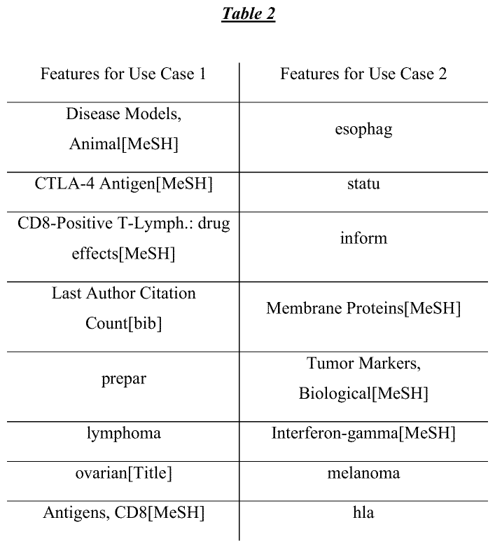

The state transitions are shown in FIG. 2, and each transition has a unique meaning and significance.
1. Initial Discovery (ID) to Translational Success (TS): This transition is the most direct example of translational success. One would want to accelerate it by identifying the most promising initial discoveries.
2. Initial Discovery (ID) to Translational Failure (TF): This transition represents translational failure when a discovery does not impact clinical care. Failures are unavoidable since every line of genuine research (i.e., involving novel hypotheses that may be corroborated or refuted by experiment) will not always yield the desired results. It is very useful however to predict which research will fail with very high probability, if possible, so resources can be reallocated.
3. Initial Discovery (ID) to Stalled Research (SR) to Translational Success (TS):

This transition represents the case where research stalls but eventually is successful. Ideally we want to avoid prematurely abandoning research.
4. Initial Discovery (ID) to Unproductive Repetition (UR) to Translational Failure (TF): This sequence of states is the case where repeated work does not lead to success. Multiple research efforts focus on a direction that ultimately fails. This path should be avoided if possible in order to prevent wasting resources.
5. Initial Discovery (ID) to Stalled Research (SR) to Waiting State (WS) to Translational Success (TS): This transition takes more time than the other transitions. Research stalls, but other discoveries are made which eventually leads to success.

In the next and final methods section we introduce the process for building a predictive model for future translational success that focuses on the most important transition of the initial discovery to translational success (i.e., transition 1 above). The purpose is to demonstrate the feasibility of modeling translational research as a Markov process and to use this framework to predict “macro-level” translational success. This transition has its own intrinsic value independent of the other transitions. Modeling other transitions follows the same methodology and will not be repeated.

### C. Prospective Predictive Model for Initial Discovery to Translational Success Transition

We use a machine learning approach similar to prior work of ours and others in text categorization and article and citation classification. The usual steps involve operational definition of positives/negatives, data design and capture, model selection and error estimation. Because of the nature of the modeling several task-specific modifications to standard protocols had to be introduced as we explain below.

### Data Design

A number of data design issues were considered to decide which articles to include in the training corpus. For example, modeling short-term impact would include recently published articles (e.g., up to 5 years old) while modeling long-term impact would require older articles. Modeling direct impact would require articles cited directly by the clinical literature, but modeling indirect impact would involve multiple citation levels. The operational definition for success that we chose for the present modeling (i.e., cited by the clinical literature) determined that only articles representing direct impact would be included regardless of the age. The topic of the article was also considered.

Using a citation network restricted to a specific topic is a different modeling task than using a network containing multiple topics. We focused on the literature involving the cancer testis antigen NY-ESO-1, which has led to targeted molecular treatments for cancer. NY-ESO-1 is a recent advancement that is clinically relevant and an ideal example of translational success. Also, the NY-ESO-1 literature is relatively small with 551 MEDLINE articles so it can be examined manually in order to manually debug the modeling process if necessary.

We defined a number of use cases to guide training corpus construction.
Use Case 1: Among articles about a given topic, which papers will lead to translational success in this topic (e.g., cited by clinical guideline about same topic)? In other words, among NY-ESO-1 articles, which articles will be cited by a clinical guideline related to NY-ESO-1?
Use Case 2: Among all topics, which papers will lead to translational success for a given topic? In other words, among all articles in Medline, which ones are likely to be cited by a clinical guideline related to NY-ESO-1?
Use Case 3: Among all topics, which papers will lead to translational success in any topic? In other words, among all articles in Medline, regardless of Ny-eso-1? which ones are likely to be cited by a clinical guideline regardless of topic?

Corpus construction started with a seed set of examples of translational success.

We first identified 31 MEDLINE-indexed clinical trials about NY-ESO-1. Corpora were constructed for Use Case 1 (i.e., predicting which NY-ESO-1 articles will be cited by NY-ESO-1 clinical trials) and Use Case 2 (i.e., predicting which articles about any topic will be cited by NY-ESO-1 clinical trials). We consider uses cases 1 and 2 for the present experiments. Article bibliographies were parsed to identify articles at citation level 1 (i.e., articles cited directly by the seed set or were connected by 1 citation).

The articles that were cited by the clinical trials were labeled as positive cases since there was a citation link connecting them to translational success. Negative examples were collected by randomly selecting articles from the same journal and volume as the positive cases. This procedure ensured that negative cases were from similar domains and same time frame as the positive cases. Negatives were also restricted to the NY-ESO-1 topic for use case 1. It was verified that the negatives were not previously included as positive cases.

Input features were extracted from each selected article, and the documents were pre-processed and formatted for learning. Input features were a combination of content and metadata (i.e., bibliometric features). Content features included the article title, abstract, and Medical Subject Heading (MeSH) terms. MEDLINE was the data source for this information. Bibliometric features included the publication history of the authors. These features were the publication and citation counts for the first and last authors in the 10 years prior to the publication of a given article. Only information available at the time of an article's publication was used. The ISI Web of Science was the data source for these features. These features were chosen since they have been useful in predicting long-term citation count and automatically classifying instrumental citations [17], [18]. Table 1 contains the full list of features where the first 3 rows are the content features.

TABLE 1
Input Features for Model Training

| Feature | Type |
|---|---|
| Article Title | >10000 |
| Article Abstract | Continuous |
| MeSH terms | Features |
| First Author Cit. Count | Integer |
| Last Author Cit. Count | |
| First Author Pub. Count | |
| Last Author Pub. Count | |

### Model Selection and Error Estimation

The corpus was used to train models for predicting which articles were likely to lead to translational success. Articles were pre-processed and formatted for learning prior to training. For content features, a bag-of-words approach was used that considered each word separately. Stopwords were removed (e.g., “a”, “the”, and other common words), and multiple forms of the same concept were eliminated with Porter stemming [19]. Then, the terms were weighted based on their frequency using log frequency with redundancy [20]. Each weight was a value between 0 and 1. The bibliometric features were normalized into values between 0 and 1 based on the maximum and minimum values for a given feature. In the end, all documents were represented as a matrix of weights (i.e., values between 0 and 1) where rows corresponded to documents and columns represented input features. Articles were labeled positive if a citation path to translational success existed. The learning task was to predict this label.

Support vector machines (SVMs) with heterogeneous polynomial kernel were chosen as the learning method. They resist overfitting and are able to handle the high-dimensional data that is typical of text data. This statistical machine learning method has been successful in many text categorization studies with biomedical articles and web sites [17], [18], [20]-[22].

Model selection was performed using a nested stratified 5-fold cross validation design [23]. SVM cost and polynomial kernel degree parameters were optimized in the inner loop (e.g., between training and validation parts of the data). Error estimation was performed in the outer loop with the remaining independent test data. The outer loop produced an unbiased estimate of model predictivity within each fold. The final estimate was averaged over all folds to reduce error estimate variance from the randomized data splits during training, validation, and testing. Performance was measured using the area under the receiver operating characteristic curve (AUC).

After model training, feature selection was performed to identify the most important features which were most associated with translational success. We selected the Markov Boundary of the response variable (i.e., translational success or cited by clinical trial) in order to reduce the total number of features to only the essential (i.e., “strongly relevant”) ones for classification. The Markov Boundary is the minimal Markov Blanket, that is the smallest set of features conditioned on which all remaining features are independent of the response variable. It excludes irrelevant and redundant variables, and it provably results in maximum variable compression and maximal predictivity under broad distributional assumptions [24]. Then, logistic regression estimated the magnitude of each feature's effect and its statistical significance.

### Results

The learning task was to predict whether an article would be cited by a clinical trial as evidence of translational success. The first model predicts which NY-ESO-1 articles will be cited by NY-ESO-1 clinical trials. Model performance was very good with an AUC of .87. For reference, an AUC of .75 indicates a mediocre classifier, an AUC of 0.85 is a very good classifier, and an AUC greater than 0.9 is an excellent classifier. This performance means that the models were able to predict which NY-ESO-1 articles would be cited by NY-ESO-1 clinical trials and lead to translational success. The second model predicts which articles, regardless of topic, would be cited by NY-ESO-1 clinical trials. Model performance was excellent with an AUC of .92. Since model performance was very good for both use cases, the results demonstrate that modeling translational research with this framework yields useful models for predicting which articles would lead to translational success.

Feature selection was performed to find the most predictive features. The total number of features was reduced to the Markov Blanket, and logistic regression was performed on the selected features. For use case 1, the original set of 15128 features was reduced to 110 features. For use case 2, the original set of 23575 features was reduced to 175 features. Table 4 lists the top 10 features ranked by absolute value of the regression coefficient. The bibliometric feature “Last Author Citation Count” was highly ranked for use case 1 where the topic was restricted to NY-ESO-1. The model for use case 2 relied on only content features.

TABLE 2
Top 10 Features for Use Cases 1 and 2

| Features for Use Case 1 | Features for Use Case 2 |
|---|---|
| Disease Models, | esophag |
| Animal[MeSH] | |
| CTLA-4 Antigen[MeSH] | statu |
| CD8-Positive T-Lymph.: drug | inform |
| effects[MeSH] | |
| Last Author Citation | Membrane Proteins[MeSH] |
| Count[bib] | |
| prepar | Tumor Markers, |
| | Biological[MeSH] |
| lymphoma | Interferon-gamma[MeSH] |
| ovarian[Title] | melanoma |
| Antigens, CD8[MeSH] | hla |

### Discussion

This report presented a method for automated, large-scale analysis of translational research. A framework was presented that modeled translational research using citation network information and defined states of translational progress using Markov processes. Corpora were constructed to train machine learning models that predicted which articles would be cited by clinical guidelines for a given topic. The experimental analysis demonstrated the feasibility of the machine learning text-categorization framework for modeling translational research and predicting success.

This work focused on the direct transition between an initial discovery and translational success. Modeling additional transitions using the approach described here is straightforward.

The present work developed and conducted preliminary validation of a novel approach for modeling translational research. Previous methods relied on manual literature reviews that do not provide generalizable information. The automated, machine learning based approach has the potential to model the entire translational research process. Being able to predict which papers will impact clinical care and lead to translational success greatly improve our understanding of the translational research process. This knowledge can guide research efforts and resource allocation. The method described here is by design domain independent and thus can be used in any R&D field.

### REFERENCES

[1] F. S. Collins, “Reengineering translational science: the time is right.,” Sci Transl Med, vol. 3, no. 90, pp. 1-6, Jul. 2011.
[2] L. W. Green, J. M. Ottoson, C. Garcia, and R. A. Hiatt, “Diffusion Theory and Knowledge Dissemination, Utilization, and Integration in Public Health,” Annu. Rev. Public. Health., vol. 30, no. 1, pp. 151-174, April 2009.
[3] Z. S. Morris, S. Wooding, and J. Grant, “The answer is 17 years, what is the question: understanding time lags in translational research,” JRSM, vol. 104, no. 12, pp. 510-520, December 2011.
[4] N. S. Sung, W. F. Crowley Jr, M. Genel, P. Salber, L. Sandy, L. M. Sherwood, S. B. Johnson, V. Catanese, H. Tilson, and K. Getz, “Central challenges facing the national clinical research enterprise,” JAMA, vol. 289, no. 10, pp. 1278-1287, 2003.
[5] D. Dougherty and P. H. Conway, “The “3T's” road map to transform US health care: the “how” of high-quality care.,” JAMA, vol. 299, no. 19, pp. 2319-2321, May 2008.
[6] M. J. Khoury, M. Gwinn, P. W. Yoon, N. Dowling, C. A. Moore, and L. Bradley, “The continuum of translation research in genomic medicine: how can we accelerate the appropriate integration of human genome discoveries into health care and disease prevention?,” Genet Med, vol. 9, no. 10, pp. 665-674, October 2007.
[7] W. Trochim, C. Kane, M. J. Graham, and H. A. Pincus, “Evaluating Translational Research: A Process Marker Model,” Clinical and Translational Science, vol. 4, no. 3, pp. 153-162, June 2011.
[8] S. Wooding, S. Hanney, M. Buxton, and J. Grant, “Payback arising from research funding: evaluation of the Arthritis Research Campaign.,” Rheumatology (Oxford), vol. 44, no. 9, pp. 1145-1156, September 2005.
[9] J. Grant, R. Cottrell, F. Cluzeau, and G. Fawcett, “Evaluating ‘payback’ on biomedical research from papers cited in clinical guidelines: applied bibliometric study.,” BMJ (Clinical research ed, vol. 320, no. 7242, pp. 1107-1111, April 2000.
[10] S. Hanney, I. Frame, J. Grant, P. Green, and M. J. Buxton, “From bench to bedside: Tracing the payback forwards from basic or early clinical research—A preliminary exercise and proposals for a future study,” The Health Economics Research Group, 2010.
[11] J. H. Comroe and R. D. Dripps, “Scientific basis for the support of biomedical science.,” Science, vol. 192, no. 4235, pp. 105-111, April 1976.
[12] J. Grant, L. Green, and B. Mason, “From bedside to bench: Comroe and Dripps revisited,” The Health Economics Research Group, 2010.
[13] Hanney, Grant, Wooding, Buxton, “Proposed methods for reviewing the outcomes of health research: the impact of funding by the UK's “Arthritis Research Campaign”,” Health Res Policy Syst, vol. 2, no. 1, pp. 4-4, July 2004.
[14] S. Hanney, I. Frame, J. Grant, M. Buxton, T. Young, and G. Lewison, “Using categorisations of citations when assessing the outcomes from health research,” Scientometrics, vol. 65, no. 3, pp. 357-379,2005.
[15] T. H. Jones, C. Donovan, and S. Hanney, “Tracing the wider impacts of biomedical research: a literature search to develop a novel citation categorisation technique,” Scientometrics, vol. 93, no. 1, pp. 125-134, February 2012.
[16] R. R. Smith, “Comroe and Dripps revisited,” BMJ (Clinical research ed, vol. 295, no. 6610, pp. 1404-1407, November 1987.
[17] L. D. Fu and C. F. Aliferis, “Using content-based and bibliometric features for machine learning models to predict citation counts in the biomedical literature,” Scientometrics, vol. 85, no. 1, pp. 257-270,2010.
[18] L. D. Fu, Y. Aphinyanaphongs, and C. F. Aliferis, “Computer models for identifying instrumental citations in the biomedical literature,” Scientometrics, vol. 97, no. 3, pp. 871-882, February 2013.
[19] M. F. Porter, “An algorithm for suffix stripping,” Program, vol. 14, pp. 130-137, 1980.
[20] E. Leopold and J. Kindermann, “Text categorization with support vector machines.,” Mach Learn, vol. 46, no. 1, pp. 423-444, 2002.
[21] Y. Aphinyanaphongs, I. Tsamardinos, A. Statnikov, D. Hardin, and C. F. Aliferis, “Text categorization models for high-quality article retrieval in internal medicine,” Journal of the American Medical Informatics Association, vol. 12, no. 2, pp. 207-216, March-April 2005.
[22] Y. Aphinyanaphongs and C. F. Aliferis, “Text categorization models for identifying unproven cancer treatments on the web.,” Stud Health Technol Inform, vol. 129, no. 2, pp. 968-972, January 2007.
[23] C. F. Aliferis, A. Statnikov, and I. Tsamardinos, “Challenges in the Analysis of Mass-Throughput Data,” Cancer Informatics, vol. 2, pp. 133-162,2006.
[24] C. F. Aliferis, A. Statnikov, I. Tsamardinos, S. Mani, and X. D. Koutsoukos, “Local Causal and Markov Blanket Induction for Causal Discovery and Feature Selection for Classification Part I: Algorithms and Empirical Evaluation,” J Mach Learn Res, vol. 11, pp. 171-234,2010.

We claim as our invention:

1. A method employing machine learning information processing utilizing documents for the identification of the activities in a research and development processes that are either likely or not likely to lead to successful completion of the research and development process within a user specified time frame, TF, comprising the following steps:
a) inputting a corpus of documents, which describe the execution of an activity or a set of activities in research and development processes, that in its totality describes similar research and development processes to a research and development process of user interest;
b) inputting for each document a time stamp, a list of cited or precedent documents within the corpus, and structured and unstructured data document content and data elements;
c) labeling each document in the corpus as successful endpoint or unsuccessful endpoint, or unknown endpoint status;
d) inputting a document D and a desired time frame TF, describing a research and development activity having an unknown likelihood to reach successful endpoint status within TF from the time of creation of the document;
e) generating a time-ordered dependency graph starting from documents with the largest time stamps and working backward (early) in time, using the list of cited precedent documents to construct the graph using standard graph construction methods;
f) labeling each document D(i) in the corpus as leading to success within TF if and only if there is a forward in time directed path from each D(i) to one or more documents that are designated as successful endpoints;
g) labeling each document D(i) in the corpus as not leading to success within TF if there is no forwarded in time directed path to one or more documents designated as successful endpoints; and
h) applying to the labeled corpus a computer-implemented sequence of machine learning model selection, model fitting, and error estimation steps and outputting:
i) one or more best models that predict the likelihood of a document to reflect a successful activity in the R&D process captured by the corpus;
ii) estimated predictivity of the models output in claim step h)i);
iii) prediction of the models output in claim step h)i) for document D and list of document content terms or meta data that have high predictivity and thus operational importance for the likelihood of success.

2. The machine learning method of claim 1 in which the following step is performed after step 1)e):
generating a dependency graph by not using the citations (ie dependency links) that are deemed non-instrumental by application of a quality filter, F, and tailored to the corpus in use.

3. The method of claim 1 implemented in computer system that automates all steps of claim 1 except the user inputs.

4. The method of claim 1 with choice of documents/corpora tailored to general translational success in the life sciences where:
a) the corpus in step 1)a) is the corpus of biomedical research and patent publications and their citations and author and institutional bibliographic meta data;
b) successful endpoint” in step 1)c) is defined as a successful clinical trial for a new treatment or an adopted clinical guideline;
c) the dependency graph method in step 1)e) wherein the dependency graph is equivalent to a citation graph identifying citation paths linking documents to translational success;
d) the machine learning protocol in step 1)h) comprises nested cross validation, area under the ROC curve (AUC), markov boundary feature selection, bag-of-words text representation, and support vector machine classifiers.

5. The method of claim 1 where other appropriate machine learning protocols are used to execute step 1)h).

6. The method of claim 1 where other appropriate graph path search algorithms are used.
